(19) United States
(12) Patent Application Publication
(10) Pub. No.: US 2026/0222948 A1
(43) Pub. Date: Jul. 30, 2026

(54) MULTIPATH RELAY WITH PRIMARY CELL SWITCH

(71) Applicants: Henry CHANG, San Diego, CA (US); Kyocera Corporation, Kyoto (JP)

(72) Inventors: Henry CHANG, San Diego, CA (US); Masato FUJISHIRO, Yokohama (JP)

(21) Appl. No.: 19/146,812

(22) PCT Filed: Feb. 7, 2024
(86) PCT No.: PCT/US2024/014824

§ 371 Date: Jul. 9, 2025

Related U.S. Application Data
(60) Provisional application No. 63/446,108, filed on Feb. 16, 2023.

(51) Int. Cl. H04W 36/08; H04B 17/318; H04W 36/00; H04W 36/36; H04W 76/20

(52) U.S. Cl. CPC H04W 36/08; H04B 17/328; H04W 36/00837; H04W 36/362; H04W 76/20

(57) ABSTRACT

The devices, systems, and methods described herein are directed to a procedure for automatically switching which cell serves as the Primary Cell (PCell) for a user equipment (UE) device connected to a network via two different communication paths. In some examples, the PCell transmits a message to the remote UE device, indicating one or more conditions that will trigger automatically switching from using a first cell as the PCell to using a second cell as the PCell. In response to one or more of the conditions that will trigger automatically switching being met, a procedure is performed to automatically switch from using the first cell as the PCell to using the second cell as the PCell. In some examples, the remote UE device will transmit a report to the PCell, indicating that one or more of the conditions that will trigger automatically switching has been met.

### CLAIM OF PRIORITY

The present application claims priority to Provisional Application No. 63/446,108, entitled “Multipath Relay with Primary Cell Switch,” docket number TPRO 00384 US, filed Feb. 16, 2023, assigned to the assignee hereof and hereby expressly incorporated by reference in its entirety.

### FIELD

This invention generally relates to wireless communications and more particularly to primary cell switching.

### BACKGROUND

Allowing a user equipment (UE) device to connect with a network via multiple pathways has a potential to improve the reliability/robustness of the UE device's connection to the network and to increase the throughput of information exchanged between the UE device and the network.

### SUMMARY

The devices, systems, and methods described herein are directed to a procedure for automatically switching which cell serves as the Primary Cell (PCell) for a user equipment (UE) device connected to a network via two different communication paths. In some examples, the PCell transmits a message to the remote UE device, indicating one or more conditions that will trigger automatically switching from using a first cell as the PCell to using a second cell as the PCell. In response to one or more of the conditions that will trigger automatically switching being met, a procedure is performed to automatically switch from using the first cell as the PCell to using the second cell as the PCell. In some examples, the remote UE device will transmit a report to the PCell, indicating that one or more of the conditions that will trigger automatically switching has been met.

### BRIEF DESCRIPTION OF THE DRAWINGS

FIG. 1A is a block diagram of an example of a system in which a remote user equipment (UE) device has established an indirect communication path and a direct communication path to a network.

FIG. 1B is a block diagram of an example of the system of FIG. 1A where the remote UE device has moved out-of-coverage (OoC) of the cell that was providing the direct communication path to the network.

FIG. 1C is a block diagram of an example of the system of FIG. 1A where a Radio Link Failure has occurred in the indirect communication path.

FIG. 2A is a block diagram of an example of the base station shown in FIGS. 1A-1C.

FIG. 2B is a block diagram of an example of the UE devices shown in FIGS. 1A-1C.

FIG. 3 is a flow chart of an example of a method performed at a remote UE device.

### DETAILED DESCRIPTION

In some multipath scenarios, a remote UE device may be connected to the network via a direct communication path and an indirect communication path. Oftentimes, the remote UE device initially establishes a connection to a base station of the network via the indirect communication path since the remote UE device may be out-of-coverage (OoC) of the cells provided by the base station. In these cases, the remote UE device would initially establish an indirect communication path to the network via a relay UE device that is in coverage of the base station. Once the remote UE device moves in-coverage of a cell provided by the base station, the remote UE device may additionally connect to the base station via a direct communication path, while keeping the indirect communication path (e.g., via the relay UE device) for better robustness.

In some examples, the cell serving the direct communication path is different than the cell serving the indirect communication path. Moreover, many of the examples described below assume that the two cells respectively serving the direct communication path and the indirect communication path are both provided by the same gNB (e.g., base station).

Typically, when a UE device is connected to a single serving cell, the cell is considered to be the Primary Cell (PCell). In Dual Connectivity (DC), the PCell is typically used as the anchor cell if the remote UE device needs to perform a Radio Resource Control (RRC) Reestablishment procedure in the event of a Radio Link Failure (RLF) of the connection between the remote UE device and the network. When the remote UE device has two communication paths to the network (e.g., direct and indirect), it may be advantageous for the serving cell of the direct communication path to be the PCell.

This concept can be applied when the remote UE device initially connects to the gNB via the indirect communication path, which would occur when the remote UE device is initially OoC of the cells provided by the gNB, in some examples. Upon establishment of the connection to the network via the indirect communication path, the remote UE device has only one serving cell, which functions as the PCell. However, once the direct communication path is added to form the multipath relay (e.g., comprising the indirect and direct communication paths), the PCell is switched from the indirect communication path to the direct communication path, in some examples. Thus, when the remote UE device is under the multipath relay configuration and the direct communication path experiences RLF, it may be necessary to switch the PCell from the direct communication path to the indirect communication path.

The devices, systems, and methods described herein are directed to a procedure for automatically switching which cell serves as the PCell for a UE device connected to a network via two different communication paths. In some examples, the PCell transmits a message to the remote UE device, indicating one or more conditions that will trigger automatically switching from using a first cell as the PCell to using a second cell as the PCell. In response to one or more of the conditions that will trigger automatically switching being met, a procedure is performed to automatically switch from using the first cell as the PCell to using the second cell as the PCell. In some examples, the remote UE device will transmit a report to the PCell, indicating that one or more of the conditions that will trigger automatically switching has been met.

Although the different examples described herein may be discussed separately, any of the features of any of the examples may be added to, omitted from, or combined with any other example. Similarly, any of the features of any of the examples may be performed in parallel or performed in a different manner/order than that described or shown herein.

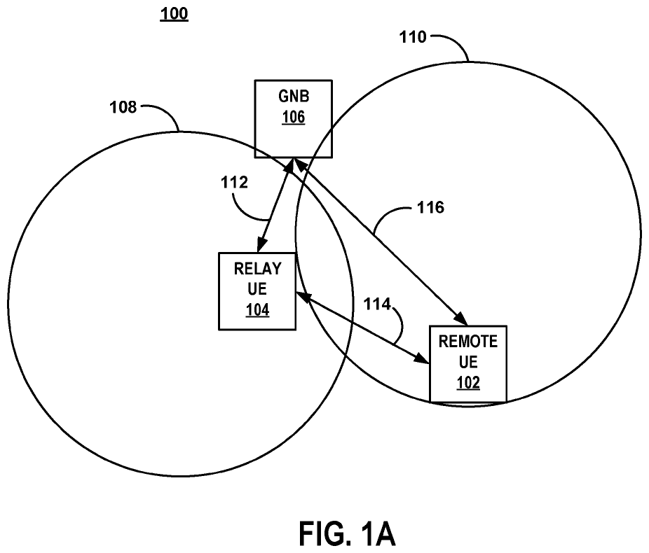

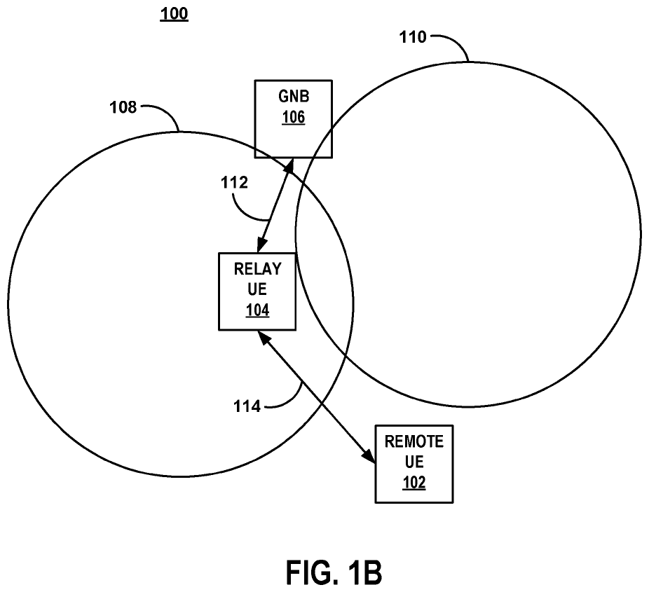

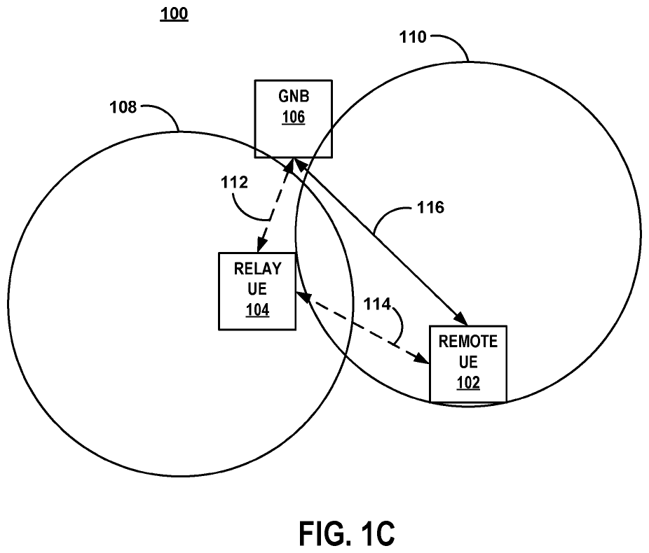

FIG. 1A is a block diagram of an example of a system in which a remote UE device has established an indirect communication path and a direct communication path to a network. More specifically, system 100 includes remote UE device 102, relay UE device 104, and base station 106. In the interest of brevity, FIG. 1A only depicts one remote UE device 102, one relay UE device 104, and one base station 106. However, any suitable number of UE devices and/or base stations may be utilized, in other examples.

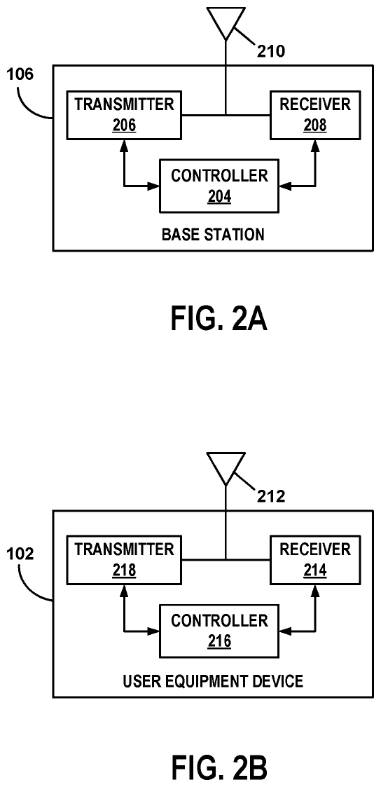

As shown in FIG. 2B, user equipment device (UE) 102 comprises controller 216, transmitter 218, receiver 214, and antenna 212, as well as other electronics, hardware, and software code. UE device 102 may also be referred to herein as a UE or as a wireless communication device (WCD). UE device 102 is wirelessly connected to a radio access network (not shown) via base station 106, which provides various wireless services to UE device 102. For the example shown in FIG. 1A, UE device 102 operates in accordance with at least one revision of the 3rd Generation Partnership Project 5G New Radio (3GPP 5G NR) communication specification. In other examples, UE device 102 may operate in accordance with other communication specifications. For the examples shown in FIGS. 1A-1C, all of the UE devices have the same components, circuitry, and configuration as UE device 102 from FIG. 2B. However, any of the UE devices in FIGS. 1A-1C may have components, circuitry, and configuration that differ from UE device 102, in other examples.

UE device 102 is any fixed, mobile, or portable equipment that performs the functions described herein. The various functions and operations of the blocks described with reference to UE device 102 may be implemented in any number of devices, circuits, or elements. Two or more of the functional blocks may be integrated in a single device, and the functions described as performed in any single device may be implemented over several devices.

Controller 216 includes any combination of hardware, software, and/or firmware for executing the functions described herein as well as facilitating the overall functionality of a user equipment device. An example of a suitable controller 216 includes software code running on a microprocessor or processor arrangement connected to memory. Transmitter 218 includes electronics configured to transmit wireless signals. In some situations, transmitter 218 may include multiple transmitters. Receiver 214 includes electronics configured to receive wireless signals. In some situations, receiver 214 may include multiple receivers. Receiver 214 and transmitter 218 receive and transmit signals, respectively, through antenna 212. Antenna 212 may include separate transmit and receive antennas. In some circumstances, antenna 212 may include multiple transmit and receive antennas.

Transmitter 218 and receiver 214 in the example of FIG. 2B perform radio frequency (RF) processing including modulation and demodulation. Receiver 214, therefore, may include components such as low noise amplifiers (LNAs) and filters. Transmitter 218 may include filters and amplifiers. Other components may include isolators, matching circuits, and other RF components. These components in combination or cooperation with other components perform the user equipment device functions. The required components may depend on the particular functionality required by the user equipment device.

Transmitter 218 includes a modulator (not shown), and receiver 214 includes a demodulator (not shown). The modulator can apply any one of a plurality of modulation orders to modulate the signals to be transmitted by transmitter 218. The demodulator demodulates received signals, in accordance with one of a plurality of modulation orders.

In the example of FIG. 1A, base station 106 provides wireless services to UE devices within cell 108 and cell 110. In other examples, base station 106 may have a coverage area that includes additional cells that are not explicitly shown in FIG. 1A. For the example shown in FIG. 1A, base station 106, sometimes referred to as a gNodeB or gNB, can receive uplink messages from UE devices and can transmit downlink messages to the UE devices.

Base station 106 is connected to the network through a backhaul (not shown) in accordance with known techniques. As shown in FIG. 2A, base station 106 comprises controller 204, transmitter 206, receiver 208, and antenna 210 as well as other electronics, hardware, and code. Base station 106 is any fixed, mobile, or portable equipment that performs the functions described herein. The various functions and operations of the blocks described with reference to base station 106 may be implemented in any number of devices, circuits, or elements. Two or more of the functional blocks may be integrated in a single device, and the functions described as performed in any single device may be implemented over several devices.

For the example shown in FIG. 2A, base station 106 may be a fixed device or apparatus that is installed at a particular location at the time of system deployment. Examples of such equipment include fixed base stations or fixed transceiver stations. In some situations, base station 106 may be mobile equipment that is temporarily installed at a particular location. Some examples of such equipment include mobile transceiver stations that may include power generating equipment such as electric generators, solar panels, and/or batteries. Larger and heavier versions of such equipment may be transported by trailer. In still other situations, base station 106 may be a portable device that is not fixed to any particular location. Accordingly, base station 106 may be a portable user device such as a UE device in some circumstances.

Controller 204 includes any combination of hardware, software, and/or firmware for executing the functions described herein as well as facilitating the overall functionality of base station 106. An example of a suitable controller 204 includes code running on a microprocessor or processor arrangement connected to memory. Transmitter 206 includes electronics configured to transmit wireless signals. In some situations, transmitter 206 may include multiple transmitters. Receiver 208 includes electronics configured to receive wireless signals. In some situations, receiver 208 may include multiple receivers. Receiver 208 and transmitter 206 receive and transmit signals, respectively, through antenna 210. Antenna 210 may include separate transmit and receive antennas. In some circumstances, antenna 210 may include multiple transmit and receive antennas.

Transmitter 206 and receiver 208 in the example of FIG. 2A perform radio frequency (RF) processing including modulation and demodulation. Receiver 208, therefore, may include components such as low noise amplifiers (LNAs) and filters. Transmitter 206 may include filters and amplifiers. Other components may include isolators, matching circuits, and other RF components. These components in combination or cooperation with other components perform the base station functions. The required components may depend on the particular functionality required by the base station.

Transmitter 206 includes a modulator (not shown), and receiver 208 includes a demodulator (not shown). The modulator modulates the signals that will be transmitted and can apply any one of a plurality of modulation orders. The demodulator demodulates any uplink signals received at base station 106 in accordance with one of a plurality of modulation orders.

As shown in the example of FIG. 1A, remote UE device 102 is located out-of-coverage of cell 108 and has established an indirect communication path to the network via relay UE device 104, which is in-coverage of cell 108. In the example shown in FIG. 1A, the indirect communication path includes (1) Uu communication link 112 between base station 106 and relay UE device 104, and (2) PC5 communication link 114 between relay UE device 104 and remote UE device 102. A PC5 communication link may also be referred to herein as a Sidelink.

Remote UE device 102 is located in-coverage of cell 110 and has established a direct communication path to the network without releasing the indirect communication path to the network. In the example shown in FIG. 1A, the direct communication path includes Uu communication link 116 between base station 106 and remote UE device 102. Together, the indirect communication path and the direct communication path comprise a multipath relay configuration of remote UE device 102. In the example shown in FIG. 1A, cell 110 is serving as the PCell for remote UE device 102.

In the multipath relay configuration, it may be advantageous for remote UE device 102 to have the ability to automatically switch which cell 108, 110 is serving as the PCell, depending on the condition/quality of the indirect and direct communication paths. Thus, in some examples, base station 106 transmits, to remote UE device 102 via cell 110, a message indicating one or more conditions that will trigger automatically switching from using cell 110 as the PCell to using cell 108 as the PCell. In other examples, the message indicating one or more conditions that will trigger automatically switching from using cell 110 as the PCell to using cell 108 as the PCell may be transmitted to remote UE device 102 from base station 106 via a cell other than cell 110 and/or may be transmitted to remote UE device 102 by another base station (e.g., not explicitly shown in FIG. 1A).

In some examples, the message indicating the one or more conditions that will trigger automatically switching from using cell 110 as the PCell to using cell 108 as the PCell is a Conditional RRC Reconfiguration message. Examples of conditions that will trigger automatically switching from using cell 110 as the PCell to using cell 108 as the PCell include: an out-of-coverage status (OoC) of remote UE device 102, a Radio Link Failure of the direct communication path, and a Reference Signal Received Power (RSRP) value of the direct communication path being below a threshold value. Of course, any other suitable conditions may be utilized to trigger the automatic switching, in other examples.

FIG. 1B is a block diagram of an example of the system of FIG. 1A where the remote UE device has moved out-of-coverage (OoC) of the cell that was providing the direct communication path to the network. More specifically, FIG. 1B shows that remote UE device 102 has moved OoC of cell 110, which was providing the direct communication path to the network. It is assumed that remote UE device 102 received a message indicating one or more conditions that will trigger automatically switching from using cell 110 as the PCell to using cell 108 as the PCell. In the example shown in FIG. 1B, one of the conditions that will trigger automatically switching from using cell 110 as the PCell to using cell 108 as the PCell is an OoC status of remote UE device 102.

Thus, remote UE device 102 uses its controller 216 to determine that one or more of the conditions that will trigger automatically switching has been met. More specifically, remote UE device 102 determines that remote UE device 102 is OoC of cell 110, in the example of FIG. 1B. In response to the determination that one or more of the conditions that will trigger automatically switching has been met, remote UE device 102 uses its controller 216 to automatically switch from using cell 110 as the PCell to using cell 108 as the PCell. More specifically, remote UE device 102 automatically switches from using cell 110 as the PCell to using cell 108 as the PCell, in response to the determination that remote UE device 102 is OoC of cell 110, in the example of FIG. 1B.

In addition to automatically switching which cell is serving as the PCell for remote UE device 102, remote UE device 102 also transmits, via its transmitter 218 and antenna 212, a report indicating that one or more of the conditions that will trigger automatically switching has been met. Base station 106 receives the report indicating that one or more of the conditions that will trigger automatically switching has been met and, therefore, is made aware that remote UE device 102 is using cell 108 as its PCell. In further examples, one or more additional base stations may also receive the report indicating that one or more of the conditions that will trigger automatically switching has been met and, therefore, are made aware that remote UE device 102 is using cell 108 as its PCell.

In other examples in which a Radio Link Failure (RLF) is detected in the direct communication path, remote UE device 102 may transmit, via the indirect communication path, a report (1) informing the PCell that remote UE device 102 is out-of-coverage (OoC), and (2) indicating the RLF of the direct communication path. In some of these examples, the report informing the PCell that remote UE device 102 is OoC and indicating the RLF of the direct communication path is received by base station 106 and/or one or more additional base stations.

In other examples in which the direct communication path experiences RLF and remote UE device 102 reports the RLF to the PCell via the indirect communication path, the PCell may have some expectation that remote UE device 102 may be able to recover from the RLF if remote UE device 102 is still in-coverage and connected to a Secondary Cell (SCell). However, the situation is different in a multipath relay configuration in which the direct communication path experiences RLF and only the indirect communication path remains connected. In these multipath relay scenarios, it is likely that, when remote UE device 102 is only PC5 connected to relay UE device 104, remote UE device 102 is already OoC from base station 106, and therefore, recovery from RLF in the direct communication path is not very likely. Thus, in these situations the PCell should be reconfigured to remote UE device 102 in the indirect communication path, and if a Sidelink Radio Link Failure (SL-RLF) or an RLF subsequently occurs in the indirect communication path, remote UE device 102 may perform a re-establishment procedure.

FIG. 1C is a block diagram of an example of the system of FIG. 1A where a Radio Link Failure (RLF) has occurred in the indirect communication path. More specifically, FIG. 1C shows that an RLF has occurred in the indirect communication path between base station 106 and remote UE device 102.

In some examples, the failure may be a loss of Uu communication link 112 between base station 106 and relay UE device 104. In some of these examples in which there is an RLF of Uu communication link 112, relay UE device 104 may send a notification to remote UE device 102 either when an RRC Reestablishment procedure with base station 106 fails or when an RRC connection is re-established with a cell belonging to a different gNB. In other examples, the failure may be a loss of PC5 communication link 114 between relay UE device 104 and remote UE device 102. In further examples, the failure may be a loss of both Uu communication link 112 and PC5 communication link 114. The failure of both communication links is shown in FIG. 1C by dashed lines 112, 114.

In the example shown in FIG. 1C, a failure in the indirect communication path causes remote UE device 102 to transmit, via the direct communication path, a report informing the PCell of a Radio Link Failure (e.g., SL-RLF or a Uu RLF) in the indirect communication path. As part of this failure report, remote UE device 102 may also provide Sidelink Reference Signal Received Power/Sidelink Discovery Reference Signal Received Power (SL-RSRP/SD-RSRP) measurements of candidate relay UE devices based on the latest RRC Reconfiguration sent to the remote UE device from the PCell, in some examples.

Although many of the foregoing examples are described within the context of automatically switching which cell is serving as the PCell in multipath relaying, the concepts described herein may be applied to other scenarios. For example, the concepts described herein may be applicable to Carrier Aggregation (CA) scenarios involving changing Primary Cells/Secondary Cells (PCells/SCells) and Dual Connectivity (DC) scenarios involving changing Master Cell Groups/Secondary Cell Groups.

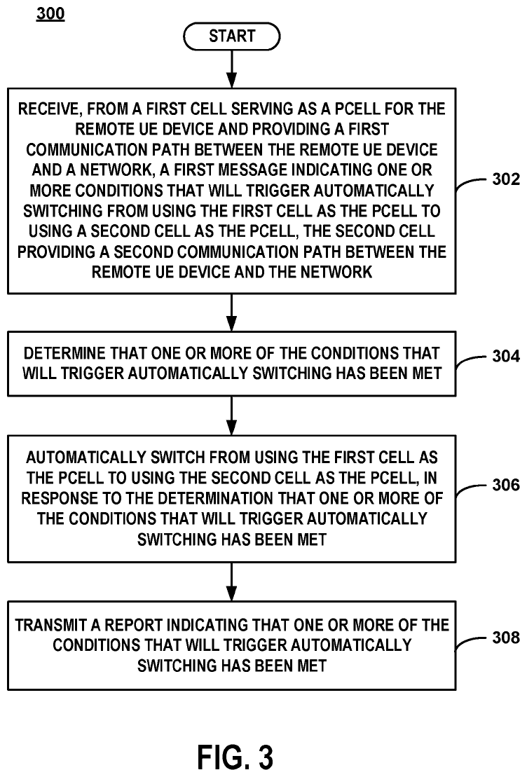

FIG. 3 is a flow chart of an example of a method performed at a remote UE device. At step 302, the remote UE device receives, from a first cell serving as a Primary Cell (PCell) for the remote UE device and providing a first communication path between the remote UE device and a network, a first message indicating one or more conditions that will trigger automatically switching from using the first cell as the PCell to using a second cell as the PCell. The second cell provides a second communication path between the remote UE device and the network. At step 304, the remote UE device determines that one or more of the conditions that will trigger automatically switching has been met. At step 306, in response to the determination that one or more of the conditions that will trigger automatically switching has been met, the remote UE device automatically switches from using the first cell as the PCell to using the second cell as the PCell. At step 308, the remote UE device transmits a report indicating that one or more of the conditions that will trigger automatically switching has been met.

In other examples, one or more of the steps of method 300 may be omitted, combined, performed in parallel, or performed in a different order than that described herein or shown in FIG. 3. In still further examples, additional steps may be added to method 300 that are not explicitly described in connection with the example shown in FIG. 3.

Clearly, other embodiments and modifications of this invention will occur readily to those of ordinary skill in the art in view of these teachings. The above description is illustrative and not restrictive. This invention is to be limited only by the following claims, which include all such embodiments and modifications when viewed in conjunction with the above specification and accompanying drawings. The scope of the invention should, therefore, be determined not with reference to the above description, but instead should be determined with reference to the appended claims along with their full scope of equivalents.

1. A remote user equipment (UE) device comprising:
a receiver configured to receive, from a first cell serving as a Primary Cell (PCell) for the remote UE device and providing a first communication path between the remote UE device and a network, a first message indicating one or more conditions that will trigger automatically switching from using the first cell as the PCell to using a second cell as the PCell, the second cell providing a second communication path between the remote UE device and the network;
a controller configured to:
determine that one or more of the conditions that will trigger automatically switching has been met, and
automatically switch from using the first cell as the PCell to using the second cell as the PCell, in response to the determination that one or more of the conditions that will trigger automatically switching has been met; and
a transmitter configured to transmit a report indicating that one or more of the conditions that will trigger automatically switching has been met.

2. The remote UE device of claim 1, wherein the first communication path is a direct communication path and the second communication path is an indirect communication path.

3. The remote UE device of claim 2, wherein the remote UE device is initially connected to the network via the indirect communication path.

4. The remote UE device of claim 2, wherein the first message indicating the one or more conditions that will trigger automatically switching from using the first cell as the PCell to using the second cell as the PCell is a Conditional RRC Reconfiguration message.

5. The remote UE device of claim 4, wherein the controller is further configured to automatically switch from using the first cell as the PCell to using the second cell as the PCell based on an out-of-coverage status (OoC) of the remote UE device.

6. The remote UE device of claim 4, wherein the controller is further configured to automatically switch from using the first cell as the PCell to using the second cell as the PCell, in response to detecting a Radio Link Failure of the direct communication path.

7. The remote UE device of claim 4, wherein the controller is further configured to automatically switch from using the first cell as the PCell to using the second cell as the PCell, if a Reference Signal Received Power (RSRP) value of the direct communication path is below a threshold value.

8. The remote UE device of claim 1, wherein the first communication path is an indirect communication path and the second communication path is a direct communication path.

9. The remote UE device of claim 1, wherein the transmitter is further configured to transmit, along the indirect communication path, a report:
informing the PCell that the remote UE device is out-of-coverage (OoC), and
indicating a Radio Link Failure has been detected in the direct communication path.

10. The remote UE device of claim 1, wherein the transmitter is further configured to transmit, along the direct communication path, a report informing the PCell of a Radio Link Failure in the indirect communication path.

11. The remote UE device of claim 1, wherein the first cell and the second cell are provided by a same base station.

12. A base station providing a first cell, the base station comprising:
a transmitter configured to transmit, to a remote user equipment (UE) device, a first message indicating one or more conditions that will trigger automatically switching from using the first cell as a Primary Cell (PCell) to using a second cell as the PCell, the first cell providing a first communication path between the remote UE device and a network and the second cell providing a second communication path between the remote UE device and the network; and
a receiver configured to receive, from the remote UE device, a report indicating that one or more of the conditions that will trigger automatically switching has been met.

13. The base station of claim 12, wherein the first communication path is a direct communication path and the second communication path is an indirect communication path.

14. The base station of claim 13, wherein the remote UE device is initially connected to the network via the indirect communication path.

15. The base station of claim 13, wherein the first message indicating the one or more conditions that will trigger automatically switching from using the first cell as the PCell to using the second cell as the PCell is a Conditional RRC Reconfiguration message.

16. The base station of claim 15, wherein one of the conditions that will trigger automatically switching from using the first cell as the PCell to using the second cell as the PCell is an out-of-coverage status (OoC) of the remote UE device.

17. The base station of claim 15, wherein one of the conditions that will trigger automatically switching from using the first cell as the PCell to using the second cell as the PCell is a Radio Link Failure of the direct communication path.

18. The base station of claim 15, wherein one of the conditions that will trigger automatically switching from using the first cell as the PCell to using the second cell as the PCell is when a Reference Signal Received Power (RSRP) value of the direct communication path is below a threshold value.

19. The base station of claim 12, wherein the first communication path is an indirect communication path and the second communication path is a direct communication path.

20. The base station of claim 12, wherein the receiver is further configured to receive, from the remote UE device, a report:
informing the PCell that the remote UE device is out-of-coverage (OoC), and
indicating a Radio Link Failure has been detected in the direct communication path.

21. The base station of claim 12, wherein the receiver is further configured to receive, along the direct communication path, a report informing the PCell of a Radio Link Failure in the indirect communication path.

22. The base station of claim 12, wherein the first cell and the second cell are provided by the base station.

23. A remote user equipment (UE) device comprising:
a controller configured to:
determine a Radio Link Failure (RLF) of an indirect communication path between the remote UE device and a network has occurred when a Sidelink Radio Link Failure (SL-RLF) has occurred in a PC5 communication link between the remote UE device and a relay UE device, the indirect communication path provided by a first cell serving as a Secondary Cell (SCell) for the remote UE device, and
determine an RLF of the indirect communication path has occurred when a first report is received, from the relay UE device, indicating an RLF of a Uu communication link between the relay UE device and the network; and
a transmitter configured to transmit, via a direct communication path between the remote UE device and the network, a second report:
indicating that an RLF of the indirect communication path has occurred, and
including at least one of the following: Sidelink Reference Signal Received Power (SL-RSRP) measurements of candidate relay UE devices, and Sidelink Discovery Reference Signal Received Power (SD-RSRP) measurements of candidate relay UE devices,
the direct communication path provided by a second cell serving as a Primary Cell (PCell) for the remote UE device.

24. The remote UE device of claim 23, further comprising:
a receiver configured to receive, from the PCell, a Radio Resource Control (RRC) Reconfiguration message indicating which measurements to include in the second report.
